(19) United States
(12) Patent Application Publication
(10) Pub. No.: US 2007/0001608 A1
(43) Pub. Date: Jan. 4, 2007

(54) Paste composition

(76) Inventors: Eun-sung Lee, Seoul (KR); Jae-young Choi, Suwon-si (KR); Seul-ki Kim, Goyang-si (KR); Seon-mi Yoon, Yongin-si (KR); Nam-seok Baik, Suwon-si (KR); Yong-jun Jang, Cheonan-si (KR)

Correspondence Address: CANTOR COLBURN, LLP, 55 GRIFFIN ROAD SOUTH, BLOOMFIELD, CT, 06002, US

(21) Appl. No.: 11/479,811

(22) Filed: Jun. 30, 2006

(30) Foreign Application Priority Data
Jun. 30, 2005 (KR) 10-2005-0058639

(51) Int. Cl. H01J 17/49

(52) U.S. Cl. 313/587

(57) ABSTRACT

Provided is paste composition that includes inorganic particles, an organic solvent, and a phosphate ester dispersant having a hydrophilic moiety with an alkylene group. The dispersant has good dispersibility and strong viscosity decreasing ability, so that contains more inorganic particles than a conventional paste composition at the same viscosity. Thus, a display device prepared using the paste composition has a better packing density.

### CROSS-REFERENCE TO RELATED PATENT APPLICATION

This application claims priority from Korean Patent Application No. 10-2005-0058639, filed on Jun. 30, 2005, in the Korean Intellectual Property Office, the disclosures of which are incorporated herein in its entirety by reference.

### FIELD OF THE INVENTION

The present invention relates to a paste composition. More particularly, the present invention relates to a paste composition including a phosphate dispersant having a hydrophobic moiety with arylene group.

### DESCRIPTION OF THE RELATED ART

Display devices, which are major elements of information delivery systems, are mainly used as Personal Computer (PC) monitors, television receivers, etc. Display devices can be largely classified into Cathode Ray Tubes (CRTs) using high-speed electrons emitted from cathodes, and recently rapidly developed flat panel displays, such as Liquid Crystal Displays (LCDs), Plasma Display Panels (PDPs), and Field Emission Displays (FEDs) or Carbon Nano Tube (CNT)-based lamps.

Among the flat panel displays, the PDPs are display devices that, when voltages are applied to transparent electrodes and a discharge occurs on a dielectric surface and a protective surface to generate UV light, phosphors coated on a rear panel are excited by the generated UV light, thereby emitting light. The FEDs and CNT-based lamps are display devices that, when a strong electric field of a gate electrode is applied to emitters arranged in a predetermined distance on a cathode, electrons are emitted from the emitters and then the emitted electrons collide with phosphors coated on the surface of an anode, thereby emitting light.

These flat panel displays are different in terms of an operational principle as described above, but a constitutional element (e.g., a phosphor layer, etc.) disposed between two panels of a flat panel display is generally formed by coating a paste composition on a substrate during display fabrication. Various components constituting the paste composition must be uniformly dispersed in the paste composition and must not be easily precipitated. By doing so, even when the paste composition is subjected to subsequent processes (e.g., sintering), display devices with uniform properties can be produced. These requirements are needed not only for the flat panel displays but also for many other display devices used in the electronic field. If the dispersibility of a paste composition is poor, it is difficult to accomplish electrical or magnetic uniformity after a curing process such as sintering.

Thus, a dispersant is generally added to a paste composition in order to enhance the dispersibility of the paste composition. For example, the use of a dispersant in a paste composition for barrier ribs of PDPs is disclosed in many technical literatures, e.g., Korean Patent Laid-Open Publication Nos. 2001-0037347 and 2003-0033564, and Japanese Patent Laid-Open Publication No. 2000-203887.

However, when used in the paste containing the inorganic particles, conventional dispersants cannot obtain substantial decrease in the viscosity of the paste. Also, there is a limit on the quantity of the inorganic particles that a conventional paste composition can contain. Therefore, the development of dispersants with both enhanced dispersibility and enhanced viscosity decrease, which enable the preparation of the paste containing more inorganic particles compare to conventional dispersants at the same viscosity, is still required.

### SUMMARY OF THE INVENTION

The present invention provides a paste composition including the dispersant with good dispersibility.

The present invention also provides a display apparatus fabricated using the paste composition.

The present invention further provides a plasma display panel including barrier ribs made of the paste composition.

According to an aspect of the present invention, there is provided a paste composition including: inorganic particles; an organic solvent; and a phosphate ester dispersant having a hydrophobic moiety with arylene group.

The dispersant may be represented by Formula 1 below:
[R₁-A-(OR₂)ₙ—(OR₃)ₘ—O]ₖ—PO(OH)₃₋ₖ Formula 1

wherein,

R₁ is a substituted or unsubstituted alkyl group of 5-30 carbon atoms;

A is a substituted or unsubstituted arylene group of 6-30 carbon atoms;

R₂ and R₃ are each independently a substituted or unsubstituted alkylene group of 2-5 carbon atoms;

k is 1 to 3; and

n and m are each independently 0 to 30 with proviso that 3≦n+m≦30.

The dispersant may also be represented by Formula 2 below:

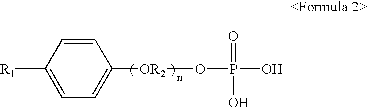

wherein,

R₁ is a substituted or unsubstituted alkyl group of 5 to 30 carbon atoms;

R₂'s are each independently a substituted or unsubstituted alkylene group of 2 to 5 carbon atoms; and

n is 0 to 30.

The dispersant may also be represented by Formula 3 below:

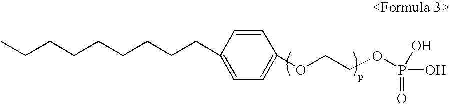

wherein p is 3 to 10.

The organic solvent may be at least one selected from the group consisting of terpineol, butyl carbitol, butyl carbitol acetate, pentene diol, dipentene, limonene, ethyleneglycol alkylether, diethyleneglycol alkylether, ethyleneglycol alkylether acetate, diethyleneglycol alkylether acetate, diethyleneglycol dialkylether acetate, triethyleneglycol alkylether acetate, triethyleneglycol alkylether, propyleneglycol alkylether, propyleneglycol phenylether, dipropyleneglycol alkylether, tripropyleneglycol alkylether, propyleneglycol alkylether acetate, dipropyleneglycol alkylether acetate, tripropyleneglycol alkylether acetate, dimethyl phthalate, diethyl phthalate, dibutyl phthalate, and distilled water.

The paste composition may include 24-80 parts by weight of the organic solvent and 0.5-3 parts by weight of the dispersant, based on 100 parts by weight of the inorganic particles.

The inorganic particles may be a glass powder, and the paste composition may further include an organic binder. In this case, the paste composition may further include an additive.

The glass powder may be at least one selected from the group consisting of PbO, BaO, SiO₂, B₂O₃, Al₂O₃, ZnO, Bi₂O₃, MgO, Na₂O, K₂O, TiO₂, ZrO₂, CuO, and SnO₂.

The organic binder may be at least one selected from the group consisting of a cellulose resin, a butyral resin, polyethylene oxide, an acrylate resin, a vinyl resin, and polypropylene carbonate.

The paste composition may include 3-6 parts by weight of the organic binder, 21-74 parts by weight of the organic solvent, and 0.5-3.0 parts by weight of the dispersant, based on 100 parts by weight of the glass powder. In this case, the paste composition may further include 0.1-3 parts by weight of the additive based on 100 parts by weight of the glass powder.

The paste composition may have a viscosity of 5,000 to 60,000 cps at a temperature of 25° C. at a shear rate of 1 sec⁻¹.

According to another aspect of the present invention, there is provided a display apparatus using the paste composition.

The display apparatus may be a plasma display panel.

The display apparatus may be a field emission display.

According to a further aspect of the present invention, there is provided a plasma display panel including barrier ribs made of the paste composition.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a plasma display panel according to the present invention;

FIG. 2 is a schematic view of a field emission display according to the present invention;

FIG. 3 is a graph illustrating the apparent viscosities of paste compositions prepared in Examples 1-2 and Comparative Examples 1-3;

FIG. 4 is a graph illustrating the apparent viscosities of paste compositions prepared in Examples 3-7 and Comparative Examples 6-10;

FIG. 5A is a Scanning Electron Microscope image of a cross section of barrier ribs for plasma display panel according to Example 21;

FIG. 5B is a Scanning Electron Microscope image of a surface of barrier ribs for plasma display panel according to Example 21;

FIG. 5C is a Scanning Electron Microscope image of a cross section of barrier ribs for plasma display panel according to Comparative Example 21;

FIG. 5D is a Scanning Electron Microscope image of a surface of barrier ribs for plasma display panel according to Comparative Example 21;

FIG. 5E is a Scanning Electron Microscope image of a cross section of barrier ribs for plasma display panel according to Comparative Example 22; and

FIG. 5F is a Scanning Electron Microscope image of a surface of barrier ribs for plasma display panel according to Comparative Example 22.

### DETAILED DESCRIPTION OF THE INVENTION

The present invention will now be described more fully with reference to the accompanying drawings, in which exemplary embodiments of the invention are shown.

The paste composition of the present invention comprises a dispersant including a hydrophobic moiety with an arylene group. In contrast to a paste composition comprising conventional dispersant with low viscosity decreasing ability, the paste composition of the present invention has both good dispersibility and strong viscosity decreasing ability, so that contains more inorganic particles than a conventional paste composition at the same viscosity. Thus, a display device prepared using the paste composition has a better packing density.

As described above, the paste composition of the present invention includes inorganic particles, an organic solvent, and an phosphate ester dispersant having hydrophobic moiety with arylene group.

As used herein, the term “dispersant” refers to, in particular, a surfactant used to promote the distribution and separation of particles. A dispersant is not necessarily a surfactant. However, since discontinuous-phase particles in a continuous phase tend to agglomerate, a surfactant, present at the interface between the continuous phase and the discontinuous-phase particles to give a repulsive force between the discontinuous-phase particles, is mainly used.

The dispersant according to the present invention includes arylene group and alkly group in the hydrophobic moiety. The arylene group forms a rigid aromatic ring. Thus, when the dispersant is adsorbed onto the interface, it is possible to increase the rigidity of the hydrophobic part. Also, it is preferable that the dispersant according to the present invention includes a hydrophilic part with alkylene oxide group and phosphate group, but the present invention is not limited hereto. Alkyleneoxide group is a representative nonionic functional group, and ethylene oxide group is an example of a hydrophilic functional group. Because it is possible to control the numbers of the alkylene oxide groups according to reaction condition, the overall dispersibility of the dispersant is controlled with convenience. And, phosphate group that is a polar functional group may be present in the form of phosphonium salt in nature (e.g., lecithin).

However, when the phosphate group exists in a form of phosphonium salt, the dispersant becomes a zwitterionic dispersant, so that the dispersant is unsuitable for the paste composition by excess increase of the repulsive force among the dispersants. Thus, phosphoric acid itself can be used as the dispersant. Because a phosphate group has a plurality of polar hydroxyl groups and a polar P═O group, it can be relatively well adsorbed onto the polar surface of the various kinds of particles.

In more detail, the alkyl group of the dispersant of the present invention is a substituted or unsubstituted alkyl group of 5-30 carbon atoms. If the alkyl group has less than 5 carbon atoms, hydrophobicity may be insufficient. On the other hand, if the alkyl group has more than 30 carbon atoms, hydrophobicity may be excessively increased. The arylene group of the dispersant is a substituted or unsubstituted arylene group of 6-30 carbon atoms. If the arylene group has less than 6 carbon atoms, it may be difficult to obtain a planar arylene group in a neutral state. On the other hand, an arylene group with more than 30 carbon atoms is very bulky, and thus, it is difficult to obtain dense adsorption of the dispersant at a particle-liquid interface. The alkylene oxide group of the dispersant is a substituted or unsubstituted alkylene oxide group of 2-10 carbon atoms. The synthesis of an alkylene oxide group with one carbon atom is difficult, and an alkylene oxide group with more than 10 carbon atoms may render the dispersant less hydrophilic. The alkyl group, the arylene group, and the alkylene oxide group may be substituted by various non-limiting substituents known in the art, thereby further reducing the surface tension of the dispersant.

In particular, the arylene group may be phenylene, indenylene, naphthalenylene, phenanthrenylene, anthracenylene, or pyrenylene, but the present invention is not limited to the illustrated examples. Of course, all arylene groups with aromaticity known in the art can be used herein.

The dispersant may be represented by Formula 1 below:
[R₁-A-(OR₂)ₙ—(OR₃)ₘ—O]ₖ—PO(OH)₃₋ₖ Formula 1

wherein,

R₁ is a substituted or unsubstituted alkyl group of 5-30 carbon atoms;

A is a substituted or unsubstituted arylene group of 6-30 carbon atoms;

R₂ and R₃ are each independently alkylene group of 2-5 carbon atoms;

k is 1 to 3; and

n and m are each independently 0 to 30 with proviso that 3≦n+m≦30.

The dispersant may also be represented by Formula 2 below:

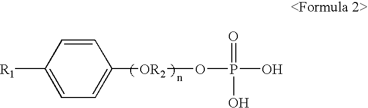

wherein,

R₁ is a substituted or unsubstituted branched alkyl group of 5-30 carbon atoms;

R₂ is each independently a linear or branched alkylene group of 2-5 carbon atoms; and

n is 0 to 30.

The dispersant may also be represented by Formula 3 below:

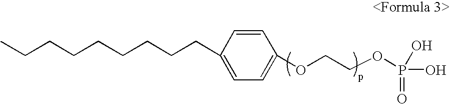

wherein p is 3 to 10.

In the present invention, the inorganic particles are not particularly limited. Thus, the inorganic particles may be any inorganic particles (e.g., inorganic oxide, metal oxide) known in the art that can be dispersed in an organic solvent, etc. to form a paste. For example, the inorganic particles may be glass particles, phosphor particles, magnetic particles, etc. In a paste formulation made of the inorganic particles, the average particle size of the inorganic particles is more important than the chemical composition of the inorganic particles. The inorganic particles used in the paste composition of the present invention may have an average particle size (D_{avg}) from 0.001 to 1,000 μm, more preferably, from 0.01 to 100 μm, and most preferably, from 0.1 to 10 μm.

The organic solvent used in the paste composition may be terpineol, butyl carbitol (BC), butyl carbitol acetate (BCA), pentene diol, dipentene, limonene, ethyleneglycol alkylether, diethyleneglycol alkylether, ethyleneglycol alkylether acetate, diethyleneglycol alkylether acetate, diethyleneglycol dialkylether acetate, triethyleneglycol alkylether acetate, triethyleneglycol alkylether, propyleneglycol alkylether, propyleneglycol phenylether, dipropyleneglycol alkylether, tripropyleneglycol alkylether, propyleneglycol alkylether acetate, dipropyleneglycol alkylether acetate, tripropyleneglycol alkylether acetate, dimethyl phthalate, diethyl phthalate, dibutyl phthalate, distilled water, or a mixture thereof, but the present invention is not limited to the illustrated examples. The organic solvent may be any solvent known in the art that can disperse the inorganic particles.

The paste composition of the present invention may be a glass paste composition including a glass powder, an organic binder, an organic solvent, and the above-described dispersant.

The glass powder used herein may be a glass frit having a thermal expansion coefficient of 60×10⁻⁷ to 90×10⁻⁷/° C. (30˜300° C.) and a softening point of 400 to 600° C. The glass powder may be selected from the group consisting of PbO—SiO₂, PbO—SiO₂—B₂O₃, PbO—SiO₂—B₂O₃—ZnO, PbO—SiO₂—B₂O₃—BaO, PbO—SiO₂—ZnO—BaO, ZnO—SiO₂, ZnO—B₂O₃—SiO₂, ZnO—K₂O—B₂O₃—SiO₂—BaO, Bi₂O₃—SiO₂, Bi₂O₃—B₂O₃—SiO₂, Bi₂O₃—B₂O₃—SiO₂—BaO, ZnO—BaO—B₂O₃—P₂O₅—Na₂O, and Bi₂O₃—B₂O₃—SiO₂—BaO—ZnO.

For example, a PbO—B₂O₃—SiO₂-based glass frit may have a composition of 35-75% PbO, 0-50% B₂O₃, 8-30% SiO₂, 0-10% Al₂O₃, 0-10% ZnO, 0-10% CaO+MgO+SrO+BaO, and 0-6% SnO₂+TiO₂+ZrO₂ by mass.

A BaO—ZnO—B₂O₃—SiO₂-based glass frit may have a composition of 20-50% BaO, 25-50% ZnO, 10-35% B₂O₃, and 0-10% SiO₂ by mass, or a composition of 3-25% BaO, 30-60% ZnO, 15-35% B₂O₃, 3-20% SiO₂, and 1-12% Li₂O+Na₂O+K₂O by mass.

A ZnO—Bi₂O₃—B₂O₃—SiO₂-based glass frit may have a composition of 25-45% ZnO, 15-40% Bi₂O₃, 10-30% B₂O₃, 0.5-10% SiO₂, and 0-24% CaO+MgO+SrO+BaO by mass.

A ZnO—BaO—B₂O₃—P₂O₅—Na₂O-based glass frit may have a composition of 30-35% ZnO, 20-25% BaO, 30-35% B₂O₃, 8-12% P₂O₅, and 3-5% Na₂O by mass.

The particle shape of the glass frit is not particularly limited, but may be spherical since spherical particles have a better packing factor and UV transmissivity than plate-like or amorphous particles. The glass frit may have an average particle size (D_{avg}) of 2 to 5 μm, a minimal particle size (Dₘᵢₙ) of 0.5 μm, and a maximal particle size (Dₘₐₓ) of 10 μm. If the average particle size of the glass frit is less than 2 μm or the minimal particle size of the glass frit is less than 0.5 μm, exposure sensitivity may be lowered or a sintering shrinkage may be increased, which makes it difficult to form desired barrier ribs of a plasma display panel. On the other hand, if the average particle size of the glass frit exceeds 5 μm or the maximal particle size of the glass frit exceeds 10 μm, the compactness and directionality of barrier ribs may be lowered.

As described above, the glass frit may have a softening point of 400 to 600° C. If the softening point of the glass frit is less than 400° C., desired-shaped barrier ribs after sintering may not be obtained. On the other hand, if the softening point of the glass frit exceeds 600° C., softening may not occur properly. The thermal expansion coefficient of the glass frit may be similar to the thermal expansion coefficient of a substrate on which barrier ribs will be formed. This is because a large difference in thermal expansion coefficients between the glass frit and the substrate can cause the distortion of the substrate, and, in serious case, substrate breakage.

Unless departing from the object of the present invention, the glass powder may further include other components, in addition to a pure glass component. Thus, the glass powder may include rare earth oxide (e.g., La₂O₃), P₂O₅, MnO, Fe₂O₃, CoO, NiO, GeO₂, Y₂O₃, MoO₃, Rh₂O₃, Ag₂O, In₂O₃, TeO₂, WO₃, ReO₂, VO₅, PdO, etc. The glass powder may also include a ceramic filler. The ceramic filler may be alumina, titania (rutile/anatase), zirconia, zircon, α-quartz, quartz glass, β-quartz solid solution, etc. In particular, when a silica-based material, such as α-quartz, is used as the ceramic filler, low-dielectric barrier ribs can be obtained, thereby reducing power consumption. Furthermore, in order to enhance the mechanical strength of barrier ribs, the ceramic filler may be partially or wholly spherical.

Thus, the glass powder may include a glass frit composed of at least one selected from the group consisting of PbO, BaO, SiO₂, B₂O₃, Al₂O₃, ZnO, Bi₂O₃, MgO, Na₂O, K₂O, TiO₂, ZrO₂, CuO, and SnO₂, and other components.

The organic binder may be a cellulose resin, a butyral resin, polyethylene oxide, polymethylmethacrylate, polyacrylester, polypropylene carbonate, etc., but the present invention is not limited to the illustrated examples. Of course, one or more of organic binders known in the art can also be used together.

More specifically, the cellulose resin serves to enhance the strength of a dry film and an adhesion between a substrate and the dry film resist. Thus, the cellulose resin may be ethylcellulose, hydroxyethylcellulose, methylcellulose, carboxymethylcellulose, etc. Ethylcellulose is particularly preferable due to its paste characteristics suitable for printing or coating of a barrier rib material.

The butyral resin plays an important role in securing an adhesion between a substrate and a dry film resist. An adhesion between a substrate and a dry film resist can be effectively secured in combination of the butyral resin with the cellulose resin. In order to accomplish desired strength and flexibility of a dry film, it is preferable to use a butyral resin with a polymerization degree of 200 to 1,000 and a weight average molecular weight (M_{w}) of 30,000 to 200,000. In order to enhance an adhesion between a substrate and a dry film, it is preferable to use a butyral resin with a butyralization degree of 70 to 80 mol %.

The use of a cellulose resin alone as the organic binder of the glass paste composition of the present invention is preferable. However, a mixture of a cellulose resin and a butyral resin with a mass ratio of 90:10 to 50:50 may also be used.

The glass paste composition of the present invention may further include a dispersant such as menhaden fish oil, polyethyleneimine, glyceryl trioleate, polyacrylic acid, corn oil, glycerin, or phosphate ester, in addition to the above-described dispersant.

The glass paste composition of the present invention may further include any other additive. The additive may be a plasticizer such as diethyl oxalate, polyethylene, polyethylene glycol, dimethyl phthalate, dibutyl phthalate, or dioctyl phthalate; an antioxidant; a leveling agent; an antifoaming agent; an antiagglomerating agent; etc.

The glass paste composition may include 3-6 parts by weight of the organic binder, 21-74 parts by weight of the organic solvent, and 0.5-3 parts by weight of the dispersant, based on 100 parts by weight of the glass powder.

If the content of the organic binder is less than 3 parts by weight, a dry film may be broken or defective. On the other hand, if it exceeds 6 parts by weight, the viscosity of a paste may be increased due to a high initial viscosity of an organic solution.

If the content of the organic solvent is less than 21 parts by weight, the viscosity of a paste may be increased due to a high initial viscosity of an organic solution. On the other hand, if it exceeds 74 parts by weight, a dry film may be broken or defective due to a relatively low content of the organic binder.

If the content of the dispersant is less than 0.5 parts by weight, inorganic particles may be insufficiently dispersed, thereby increasing the viscosity of a paste. On the other hand, if it exceeds 3 parts by weight, surplus dispersant molecules that are not attached to the surfaces of inorganic particles may be mixed with a polymer solution, thereby increasing the viscosity of a paste.

The glass paste composition may further include 0.1-3 parts by weight of the additive based on 100 parts by weight of the glass powder.

If the content of the additive is less than 0.1 parts by weight, film breakage may occur during drying. On the other hand, if it exceeds 3 parts by weight, the function of the dispersant may be hindered.

The glass paste composition of the present invention may have a viscosity of 5,000 to 60,000 cps at a temperature of 25° C. at a shear rate of 1 sec⁻¹. If the viscosity of the glass paste composition exceeds 60,000 cps, printing may not be effectively performed. On the other hand, if it is less than 5,000 cps, film formation after printing may occur poorly.

The present invention also provides a display apparatus using the paste composition. More specifically, the present invention provides a display apparatus including a sintered product formed by sintering, processing, etc. of the paste composition. The sintered product is an inorganic device with better packing density. That is, the paste composition of the present invention can make a slurry containing more inorganic particles than a conventional paste composition at the same viscosity, and the sintering of a slurry made of the paste composition of the present invention can provide a sintered product (i.e., an inorganic device) with better packing density. In the present invention, the sintered product may be a barrier rib or a phosphor layer of a PDP. The barrier rib or phosphor layer can be formed by drying, sintering, etc. of the paste composition of the present invention according to any method known in the art. For example, a barrier rib of a PDP can be formed using a screen printing process, a sand blasting process, an additive process, a photosensitive paste process, a LTCCM (Low Temperature Cofired Ceramic on Metal) process, etc.

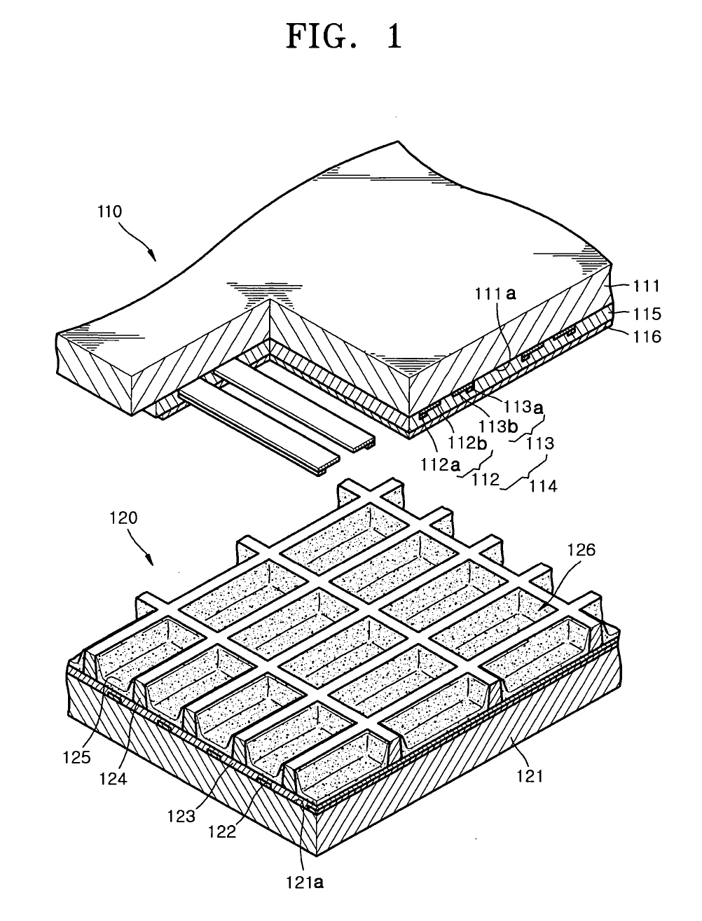

The present invention also provides a display apparatus including a sintered product obtained by sintering the paste composition of the present invention. The display apparatus of the present invention may be a plasma display panel (PDP). A PDP is illustrated in FIG. 1. With respect to the manufacturing of a PDP, referring to FIG. 1, first, electrode pairs 114, each of which includes an X electrode 113 and a Y electrode 112, are patterned on a front glass substrate 111, and bus electrodes 113a are formed. Then, the electrode pairs 114 are covered with a transparent dielectric layer 115 to protect the electrode pairs 114, and a protective layer 116 made of MgO is then formed on the transparent dielectric layer 115 to thereby complete a front panel 110.

With respect to the manufacturing of a rear panel 120, an address electrode 122 is patterned on a rear glass substrate 121 and then covered with a dielectric layer 123. Then, a paste composition of the present invention is coated on the entire surface of the dielectric layer 123, dried, processed into desired partition patterns using a sand blasting process, and sintered to thereby form barrier ribs 124. Then, a phosphor layer 125 is formed by printing and sintering a paste composition of the present invention.

A sealing material is applied onto the peripheries of the front glass substrate 111 and the rear glass substrate 121 by a dispenser. The front panel 110 and the rear panel 120 are assembled so that the electrodes of the two panels 110 and 120 are faced to each other, panelized, sintered, and degassed to inject a discharge gas, such as Ne or He—Xe, into a discharge space. Other constitutional elements of a PDP may also be made of a glass paste composition of the present invention.

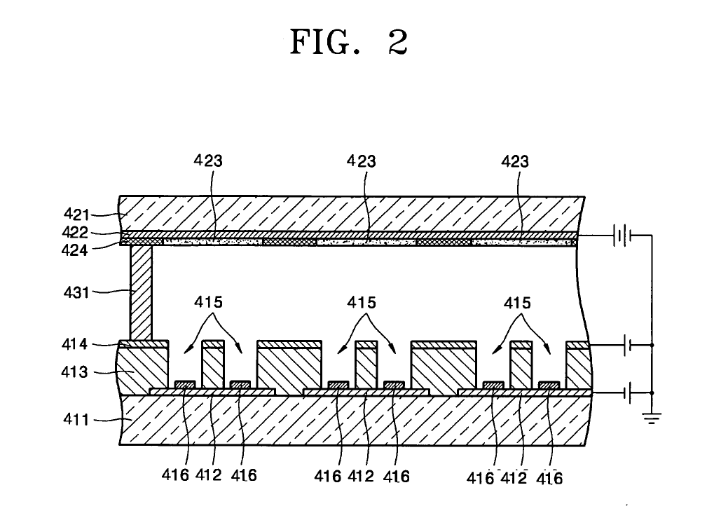

The display apparatus of the present invention may also be a field emission display (FED). A FED is illustrated in FIG. 2. Referring to FIG. 2, a FED has a triode structure composed of a cathode 412, an anode 422, and a gate electrode 414. With respect to the manufacturing of the FED, first, the cathode 412 and the gate electrode 414 are formed on a rear substrate 411 with emitters 416. Then, the anode 422 is formed on a rear surface of a front substrate 421, and a phosphor layer 423 made of a phosphor paste composition of the present invention and a black matrix 424 for contrast enhancement are formed on a rear surface of the anode 422. An insulating layer 413 and the gate electrode 414 defining microholes 415 are formed on the cathode 412. A spacer 431 is disposed between the rear substrate 411 and the front substrate 421 to maintain a distance between the two substrates 411 and 421.

A display apparatus including a sintered product obtained by sintering a paste composition of the present invention is not limited to the above-illustrated display apparatuses. That is, a sintered product obtained by sintering a paste composition of the present invention can also be applied to all other display apparatuses known in the art. A PDP including barrier ribs obtained by sintering a paste composition of the present invention is particularly preferable.

Hereinafter, the present invention will be described more specifically with reference to the following Examples and Comparative Examples. The following working examples are for illustrative purposes and are not intended to limit the scope of the present invention.

Preparation of Glass Paste Compositions

### EXAMPLE 1

37.69 g of a glass powder (85 wt % of a glass frit (35 wt % ZnO, 20 wt % BaO, 30 wt % B₂O₃, and 12 wt % P₂O₅), 5 wt % of ZnO, and 10 wt % of Al₂O₃), 1.93 g of ethyl cellulose, 8.68 g of terpineol, 8.68 g of butylcarbitol acetate, 0.4 g of dibutyl phthalate, and 0.38 g of BYK111(Product name: Disperbyk 111, BYK-chemie Inc.) that is a dispersant were mixed, stirred with a stirrer, and kneaded with a 3-roll mill to prepare a glass paste composition according to the present invention. Here, the glass powder was used conjointly with a vehicle. For this, prior to the addition of the glass powder, vehicle components were mixed to obtain the vehicle.

### EXAMPLE 2

A glass paste composition was prepared in the same manner as in Example 1 except that the dispersant RE610 (product name: RE610, Toho chemical Ltd., Japan) was used instead of the dispersant BYK111.

### EXAMPLE 3

A glass paste composition was prepared in the same manner as in Example 1 except that 23.33 g of a glass powder, 1.93 g of ethyl cellulose, 8.68 g of terpineol, 8.68 g of butylcarbitol acetate, 0.4 g of dibutyl phthalate, and 0.23 g of BYK111 that is a dispersant were used in order to make the content of the glass powder to be 25 volume % in the paste composition.

### EXAMPLE 4

A glass paste composition was prepared in the same manner as in Example 1 except that 30.5 g of a glass powder, 1.93 g of ethyl cellulose, 8.68 g of terpineol, 8.68 g of butylcarbitol acetate, 0.4 g of dibutyl phthalate, and 0.31 g of BYK111 that is a dispersant were used in order to make the content of the glass powder to be 30 volume % in the paste composition.

EXAMPLE 5

A glass paste composition was prepared in the same manner as in Example 1 except that 41 g of a glass powder, 1.93 g of ethyl cellulose, 8.68 g of terpineol, 8.68 g of butylcarbitol acetate, 0.4 g of dibutyl phthalate, and 0.4 g of BYK111 that is a dispersant were used in order to make the content of the glass powder to be 35 volume % in the paste composition.

### EXAMPLE 6

A glass paste composition was prepared in the same manner as in Example 1 except that 47 g of a glass powder, 1.93 g of ethyl cellulose, 8.68 g of terpineol, 8.68 g of butylcarbitol acetate, 0.4 g of dibutyl phthalate, and 0.47 g of BYK111 that is a dispersant were used in order to make the content of the glass powder to be 40 volume % in the paste composition.

### EXAMPLE 7

A glass paste composition was prepared in the same manner as in Example 1 except that 53 g of a glass powder, 1.93 g of ethyl cellulose, 8.68 g of terpineol, 8.68 g of butylcarbitol acetate, 0.4 g of dibutyl phthalate, and 0.53 g of BYK111 that is a dispersant were used in order to make the content of the glass powder to be 45 volume % in the paste composition.

### COMPARATIVE EXAMPLE 1

A glass paste composition was prepared in the same manner as in Example 1 except that the dispersant TX (Product name: tritonX-100, Aldrich) was used instead of the dispersant BYK111.

### COMPARATIVE EXAMPLE 2

A glass paste composition was prepared in the same manner as in Example 1 except that the dispersant IM (Product name: Unamine-O, Lonza Ltd.) was used instead of the dispersant BYK111.

### COMPARATIVE EXAMPLE 3

A glass paste composition was prepared in the same manner as in Example 1 except that the dispersant was not used.

### COMPARATIVE EXAMPLE 6

A glass paste composition was prepared in the same manner as in Comparative Example 3 except that 17.7 g of a glass powder, 1.93 g of ethyl cellulose, 8.68 g of terpineol, 8.68 g of butylcarbitol acetate, 0.4 g of dibutyl phthalate were used in order to make the content of the glass powder to be 15 volume % in the paste composition.

### COMPARATIVE EXAMPLE 7

A glass paste composition was prepared in the same manner as in Comparative Example 3 except that 23.5 g of a glass powder, 1.93 g of ethyl cellulose, 8.68 g of terpineol, 8.68 g of butylcarbitol acetate, 0.4 g of dibutyl phthalate were used in order to make the content of the glass powder to be 20 volume % in the paste composition.

### COMPARATIVE EXAMPLE 8

A glass paste composition was prepared in the same manner as in Comparative Example 3 except that 29.4 g of a glass powder, 1.93 g of ethyl cellulose, 8.68 g of terpineol, 8.68 g of butylcarbitol acetate, 0.4 g of dibutyl phthalate were used in order to make the content of the glass powder to be 25 volume % in the paste composition.

### COMPARATIVE EXAMPLE 9

A glass paste composition was prepared in the same manner as in Comparative Example 3 except that 35.3 g of a glass powder, 1.93 g of ethyl cellulose, 8.68 g of terpineol, 8.68 g of butylcarbitol acetate, 0.4 g of dibutyl phthalate were used in order to make the content of the glass powder to be 30 volume % in the paste composition.

### COMPARATIVE EXAMPLE 10

A glass paste composition was prepared in the same manner as in Comparative Example 3 except that 41 g of a glass powder, 1.93 g of ethyl cellulose, 8.68 g of terpineol, 8.68 g of butylcarbitol acetate, 0.4 g of dibutyl phthalate were used in order to make the content of the glass powder to be 35 volume % in the paste composition.

Formation of Barrier Ribs of PDPs

### EXAMPLE 21

The glass paste composition prepared in Example 1 was coated to a thickness of about 150 μm on a substrate and dried. Then, a dry film resister (DFR) film, which was an anti-abrasive photosensitive film, was laminated on a surface of the paste coating layer by pressing the DFR film using a roll so as to selectively remove the paste coating layer by subsequent sand blasting. The DFR film was then subjected to exposure to light and development to form a mask pattern for the sand blasting. In this state, when high-speed sand blasting was performed, exposed portions of the paste coating layer through the mask pattern were abraded to thereby form barrier ribs. Then, the mask pattern was removed, and the barrier ribs were sintered at a temperature of 480 to 500° C. for 30 minutes (total sintering time: 2 hours) to complete desired barrier ribs.

### COMPARATIVE EXAMPLE 21

Barrier ribs were formed in the same manner as in Example 21 except that a dispersant Aerosil (silica nano-particle, Daejoo Fine chemical, Korea) was used instead of the dispersant BYK111 to prepare the glass paste composition of Example 1.

### COMPARATIVE EXAMPLE 22

Barrier ribs were formed in the same manner as in Example 21 except that the glass paste composition prepared in Comparative Example 3 was used instead of the glass paste composition prepared in Example 1.

### EXPERIMENTAL EXAMPLE 1

### Measurement of Viscosities of Glass Paste Compositions (Dispersibility Evaluation)

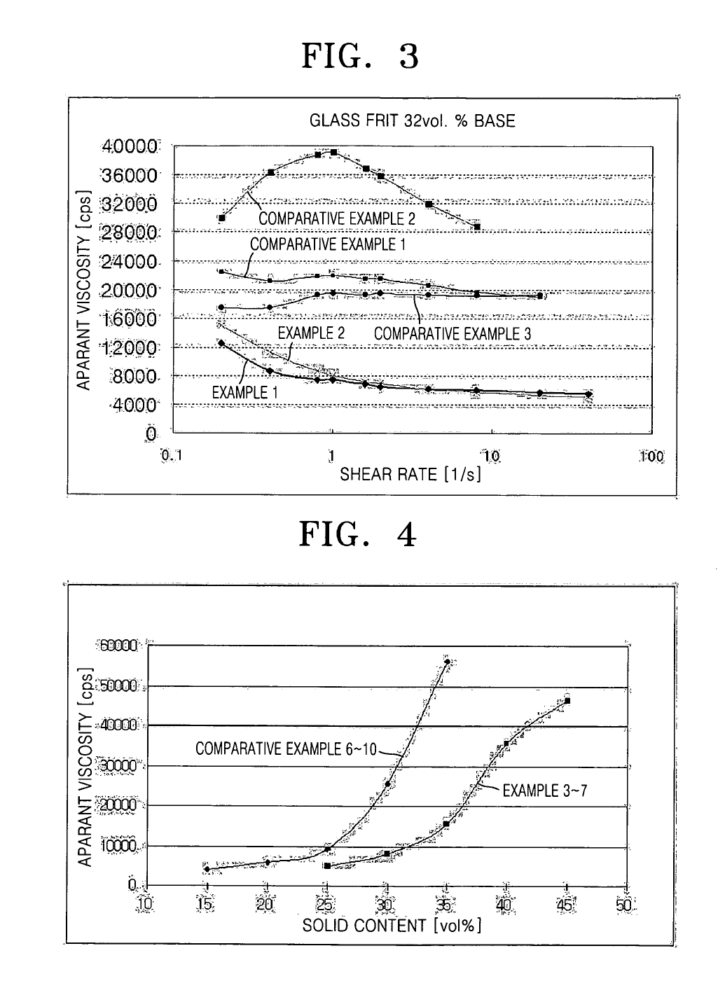

The viscosities of the glass paste compositions prepared in Example 1-2 and Comparative Examples 1-3 were measured using a brookfield viscometer (model RVII) and a cylinder-type spindle #14 at 25° C. to evaluate the dispersibility of the glass paste compositions, and the experimental results are presented in Table 1 below and shown in FIG. 3.

TABLE 1

| | Shear rate | | | | | | | | | |
|---|---|---|---|---|---|---|---|---|---|---|
| | 0.2/sec. | 0.4/sec. | 0.8/sec. | 1/sec. | 1.6/sec. | 2/sec. | 4/sec. | 8/sec. | 20/sec. | 40/sec. |
| Example 1 | 12500 | 8750 | 7500 | 7500 | 6875 | 6500 | 6250 | 6000 | 5725 | 5525 |
| Example 2 | 15000 | 11250 | 8750 | 8000 | 7188 | 7000 | 6125 | 5750 | 5400 | 5162 |
| Comparative | 22500 | 21250 | 21875 | 22000 | 21500 | 20625 | 19750 | 19050 | | |
| Example 1 | | | | | | | | | | |
| Comparative | 30000 | 36250 | 38750 | 39000 | 36875 | 35750 | 32000 | 28812 | | |
| Example 2 | | | | | | | | | | |
| Comparative | 17500 | 17500 | 19500 | 19375 | 19500 | 19375 | 19250 | 19375 | | |
| Example 3 | | | | | | | | | | |

(unit: cps)

As presented in Table 1, the glass paste composition of Examples 1-2 (phosphate dispersant having arylene group) exhibited viscosity decrease of more than 5000 cps at the shear rate of 1/sec in compare to Comparative Example 3 containing no dispersant. In contrast, the glass paste composition of Comparative Examples 1-2 containing conventional dispersants exhibited a similar or the higher viscosities in compare to Comparative Example 3. The dispersants of the present invention containing the hydrophobic and hydrophilic part in block form exhibits good dispersibility, so that the glass paste compositions of Examples 1-2 including such dispersants show low viscosity.

### EXPERIMENTAL EXAMPLE 2

### Measurement of Viscosities of Glass Paste Compositions (Solid Content Evaluation)

The dispersibility of the glass paste composition according to the solid content was evaluated by measuring the viscosities of the glass paste compositions prepared in Examples 3-7 and Comparative Examples 6-10, and the results are shown in Table 2 below.

TABLE 2

| | Viscosity at the shear rate of 8/sec. |
|---|---|
| Example 3 | 4875 |
| Example 4 | 8000 |
| Example 5 | 15500 |
| Example 6 | 35625 |
| Example 7 | 46500 |
| Comparative Example 6 | 4000 |
| Comparative Example 7 | 5800 |
| Comparative Example 8 | 9313 |
| Comparative Example 9 | 25625 |
| Comparative Example 10 | 56250 |

(unit: cps)

As presented in Table 2, the glass paste composition of Examples 3-7 exhibited the lower viscosity than Comparative Examples 6-10 at the same solid content. This is also shown in the FIG. 4. Thus, because a paste composition containing more solid content can be prepared at the same experimental condition, a paste composition having the higher packing ratio can be prepared. And, a device having the higher packing ratio and the less defects can be obtained by sintering the paste.

### EXPERIMENTAL EXAMPLE 3

### Evaluation of Uniformity of a Surface and a Cross Section of the Sintered Barrier Ribs

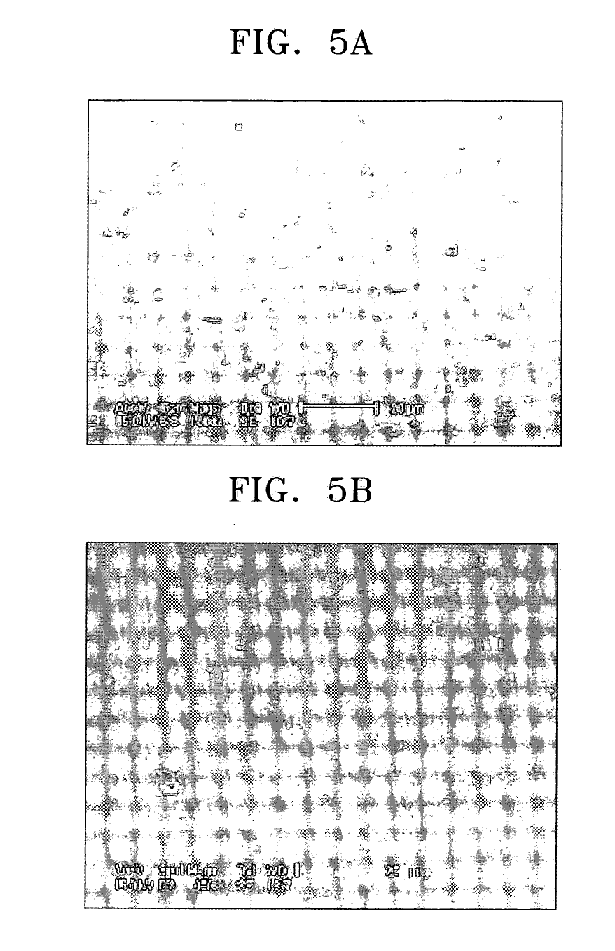

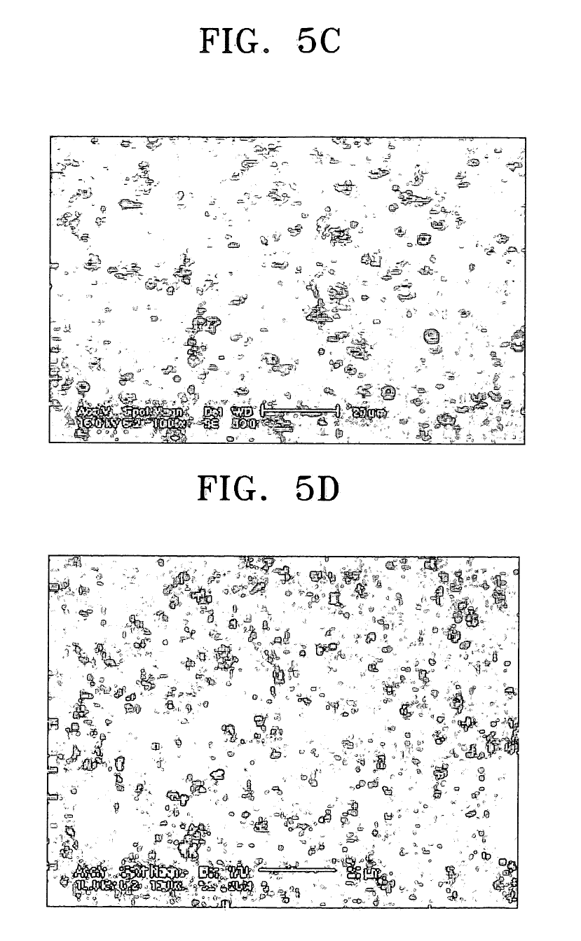

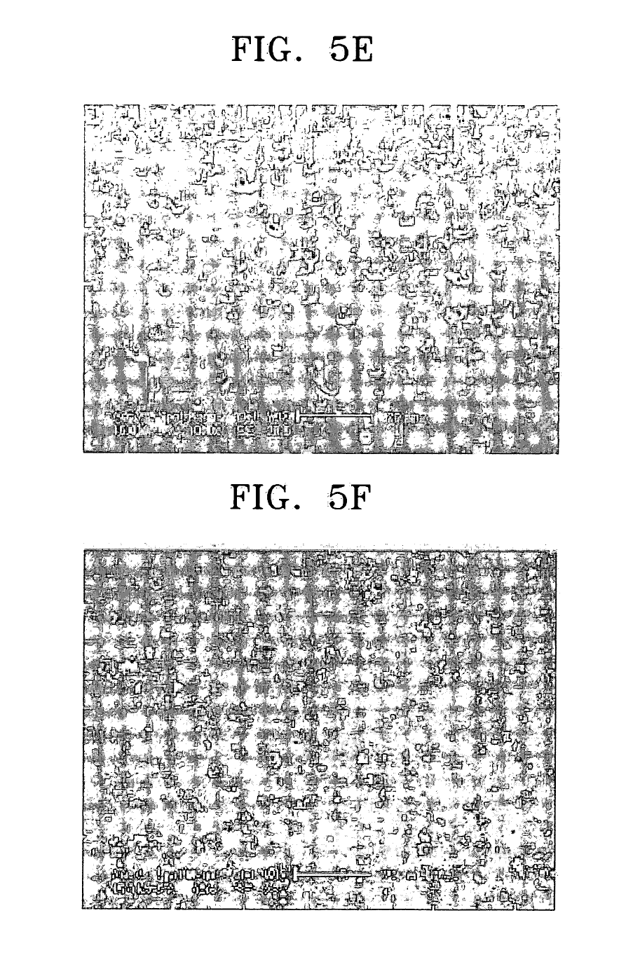

An uniformity of a surface and a cross section of the barrier ribs for PDP panels prepared according to the Example 21, and Comparative Examples 21-22 was evaluated using the scanning electron microscope. The evaluated results are shown in FIGS. 5A to 5E. As shown in FIG. 5, Example 21 (FIGS. 5A and 5B) containing the dispersant exhibited more uniform surface and cross section than Comparative Example 22 (FIGS. 5E and 5F) containing no dispersant and Comparative Example 21 (FIGS. 5C and 5D) containing only silica nano-particle. It seems that the enhancement of the uniformity of the surface and cross section is caused by the dispersion of the glass particle with the smaller size and the higher uniformity.

A paste composition of the present invention comprises a dispersant including a hydrophobic moiety with an arylene group. The paste composition of the present invention has both good dispersibility and strong viscosity decreasing ability, so that the paste composition can contain more inorganic particles than a conventional paste composition at the same viscosity. Thus, a display device prepared using the paste composition has a better packing density.

What is claimed is:

1. A paste composition comprising:
inorganic particles;
an organic solvent; and
an phosphate ester dispersant comprising a hydrophobic moiety comprising arylene group.

2. The paste composition of claim 1, wherein the dispersant is represented by Formula 1 below:
[R₁-A-(OR₂)ₙ—(OR₃)ₘ—O]ₖ—PO(OH)₃₋ₖ Formula 1
where R₁ is a substituted or unsubstituted alkyl group of 5-30 carbon atoms;
A is a substituted or unsubstituted arylene group of 6-30 carbon atoms;
R₂ and R₃ are each independently a substituted or unsubstituted alkylene group of 2-5 carbon atoms;
k is 1 to 3; and
n and m are each independently 0 to 30 with proviso that 3≦n+m≦30.

3. The paste composition of claim 1, wherein the dispersant is represented by Formula 2 below: 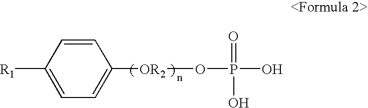
where R₁ is a substituted or unsubstituted alkyl group of 5-30 carbon atoms;
R₂ is each independently a substituted or unsubstituted alkylene group of 2-5 carbon atoms; and
n is 0 to 30.

4. The paste composition of claim 1, wherein the dispersant is represented by Formula 3 below: 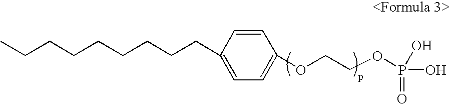
where p is 3 to 10.

5. The paste composition of claim 1, wherein the organic solvent is at least one selected from the group consisting of terpineol, butyl carbitol, butyl carbitol acetate, pentene diol, dipentene, limonene, ethyleneglycol alkylether, diethyleneglycol alkyl ether, ethyleneglycol alkylether acetate, diethyleneglycol alkylether acetate, diethyleneglycol dialkylether acetate, triethyleneglycol alkylether acetate, triethyleneglycol alkylether, propyleneglycol alkylether, propyleneglycol phenylether, dipropyleneglycol alkylether, tripropyleneglycol alkylether, propyleneglycol alkylether acetate, dipropyleneglycol alkylether acetate, tripropyleneglycol alkylether acetate, dimethyl phthalate, diethyl phthalate, dibutyl phthalate, and distilled water.

6. The paste composition of claim 1, which comprises 24-80 parts by weight of the organic solvent and 0.5-3 parts by weight of the dispersant, based on 100 parts by weight of the inorganic particles.

7. The paste composition of claim 1, wherein the inorganic particles are a glass powder, and the paste composition further comprises an organic binder.

8. The paste composition of claim 7, wherein the glass powder is at least one selected from the group consisting of PbO, BaO, SiO₂, B₂O₃, Al₂O₃, ZnO, Bi₂O₃, MgO, Na₂O, K₂O, TiO₂, ZrO₂, CuO, and SnO₂.

9. The paste composition of claim 7, wherein the organic binder is at least one selected from the group consisting of a cellulose resin, a butyral resin, polyethylene oxide, an acrylate resin, a vinyl resin, and polypropylene carbonate.

10. The paste composition of claim 7, further comprising an additive.

11. The paste composition of claim 7, which comprises 3-6 parts by weight of the organic binder, 21-74 parts by weight of the organic solvent, and 0.5-3.0 parts by weight of the dispersant, based on 100 parts by weight of the glass powder.

12. The paste composition of claim 11, further comprising 0.1-3 parts by weight of an additive based on 100 parts by weight of the glass powder.

13. The paste composition of claim 11, which has a viscosity of 5,000 to 60,000 cps at a temperature of 25° C. at a shear rate of 1 sec⁻¹.

14. A display apparatus using the paste composition of any one of claims 5 through 13.

15. The display apparatus of claim 14, which is a plasma display panel.

16. The display apparatus of claim 14, which is a field emission display.

17. A plasma display panel comprising barrier ribs made of the paste composition of any one of claims 5 through 13.
